(19) United States
(12) Patent Application Publication
(10) Pub. No.: US 2010/0110972 A1
(43) Pub. Date: May 6, 2010

(54) APPARATUS AND METHOD FOR PROCESSING THE RELAYED DATA IN A MULTIHOP RELAY BROADBAND WIRELESS ACCESS COMMUNICATION SYSTEM

(75) Inventors: Hyun-Jeong KANG, Seoul (KR); Mingxia XU, Suwon-si (KR); Taori RAKESH, Suwon-si (KR); Jung-Je SON, Yongin-si (KR); Young-Bin CHANG, Anyang-si (KR)

Correspondence Address: Jefferson IP Law, LLP, 1130 Connecticut Ave., NW, Suite 420, Washington, DC, 20036, US

(73) Assignee: Samsung Electronics Co. Ltd., Suwon-si (KR)

(21) Appl. No.: 12/612,607

(22) Filed: Nov. 4, 2009

(30) Foreign Application Priority Data
Nov. 4, 2008 (KR) 10-2008-0109100
Aug. 7, 2009 (KR) 10-2009-0072983
Aug. 13, 2009 (KR) 10-2009-0074877

(51) Int. Cl. H04J 3/08; H04W 72/04

(52) U.S. Cl. 370/315; 370/329

(57) ABSTRACT

An apparatus and a method for processing the relayed data in a multihop relay broadband wireless access communication system are provided. A method for an operation of a Relay Station (RS) includes determining whether a packet received from an upper node comprises a Relay Media Access Control (MAC) Header (RMH), when the RMH is comprised in the received packet, determining whether the RMH comprises access RS information, and when the access RS information is not comprised in the RMH, removing the RMH from the received packet and transmitting the packet to a lower Mobile Station (MS).

### PRIORITY

The present application claims the benefit under 35 U.S.C. §119(a) of a Korean patent application filed in the Korean Intellectual Property Office on Nov. 4, 2008 and assigned Serial No. 10-2008-0109100, a Korean patent application filed in the Korean Intellectual Property Office on Aug. 7, 2009 and assigned Serial No. 10-2009-0072983 and a Korean patent application filed in the Korean Intellectual Property Office on Aug. 13, 2009 and assigned Serial No. 10-2009-0074877, the entire disclosures of all of which are hereby incorporated by reference.

### BACKGROUND OF THE INVENTION

1. Field of the Invention

The present invention relates to an apparatus and a method for processing relayed data in a multihop relay broadband wireless access communication system. More particularly, the present invention relates to an apparatus and a method for distinguishing data transmitted to a relay station and data to transmit to a lower node (a relay station or a mobile station) of the relay station.

2. Description of the Related Art

A 4^{th} Generation (4G) communication system, which is a next-generation communication system, aims to provide services of various Quality of Service (QoS) levels at a data rate of about 100 Mbps. More particularly, the 4G communication system is advancing in order to guarantee mobility and QoS in a Broadband Wireless Access (BWA) communication system such as a Local Area Network (LAN) system and a Metropolitan Area Network (MAN) system. Representative examples include communication systems based on an Institute of Electrical and Electronics Engineers (IEEE) 802.16d standard (hereafter referred to as an IEEE 802.16d communication system) and an IEEE 802.16e standard (hereafter referred to as an IEEE 802.16e communication system).

The IEEE 802.16d communication system and the IEEE 802.16e communication system adopt Orthogonal Frequency Division Multiplexing (OFDM)/Orthogonal Frequency Division Multiple Access (OFDMA) schemes for physical channels. The IEEE 802.16d communication system considers only the fixed status of a current Subscriber Station (SS), that is, takes into account only a single-cell structure without considering the mobility of the SS. In contrast, the IEEE 802.16e communication system considers the mobility of the terminal in the IEEE 802.16d communication system. A mobile terminal or SS is referred to herein as a Mobile Station (MS).

FIG. 1 illustrates a simplified structure of a conventional IEEE 802.16e communication system.

Referring to FIG. 1, the IEEE 802.16e communication system has a multi-cell structure, that is, the IEEE 802.16e communication system includes a cell 100 and a cell 150. The IEEE 802.16e communication system includes a Base Station (BS) 110 which manages the cell 100, a BS 140 which manages the cell 150, and MSs 111, 113, 130, 151, and 153. Between the BSs 110 and the 140 and the MSs 111, 113, 130, 151 and 153, signals are transmitted and received in conformity with the OFDM/OFDMA scheme. Of the MSs 111, 113, 130, 151 and 153, the MS 130 travels within a boundary area between the cell 100 and the cell 150, that is, within a handover area. When the MS 130 moves to the cell 150 managed by the BS 140 while transmitting and receiving signals with the BS 110, its serving BS is changed from the BS 110 to the BS 140.

Since the signaling is conducted between the fixed BS and the MS over a direct link as shown in FIG. 1, the conventional IEEE 802.16e communication system may easily establish a radio communication link of high reliability between the BS and the MS. However, because of the fixed BS, the IEEE 802.16e communication system is subject to a low degree of flexibility in the configuration of the wireless network. Thus, in a radio environment that experiences several changes in its traffic distribution or traffic requirement, the IEEE 802.16e communication system falls short in providing an efficient communication service.

To overcome these shortcomings, using a stationary or mobile Relay Station (RS) or the conventional MSs, multihop relay data transmission may be applied to a conventional wireless cellular communication system such as IEEE 802.16e communication system. The multihop relay wireless communication system may reconfigure the network by promptly handling the communication environment change and operate the entire radio network more efficiently. For example, the multihop relay wireless communication system may expand the cell service coverage area and increase the system capacity. When there are poor channel conditions between the BS and the MS, the multihop relay wireless communication system may establish a multihop relay path via the RS by installing the RS between the BS and the MS, to thus provide the MS with a better radio channel. In addition, by employing the multihop relay scheme in a cell boundary area in the poor channel conditions from the BS, the multihop relay wireless communication system may provide a high-speed data channel and expand the cell service coverage area.

A structure of the multihop relay wireless communication system for extending service coverage of a BS is described below with reference to FIG. 2.

FIG. 2 depicts a simplified structure of a multihop relay wireless broadband communication system for extending service coverage of a BS according to the conventional art.

Referring to FIG. 2, the multihop relay wireless communication system has a multi-cell structure, that is, it includes a cell 200 and a cell 240. The multihop relay wireless communication system includes a BS 210 which manages the cell 200, a BS 250 which manages the cell 240, MSs 211 and 213 in the cell 200, MSs 221 and 223 managed by the BS 210 but in the coverage area 230 outside the cell 200, an RS 220 which provides multihop relay paths between the BS 210 and the MSs 221 and 223 in the coverage area 230, MSs 251, 253 and 255 in the cell 240, MSs 261 and 263 managed by the BS 250 in the coverage area 270 outside the cell 240, and an RS 260 which provides multihop relay paths between the BS 250 and the MS 261 and 263 in the coverage area 270. Between the BSs 210 and 250, the RSs 220 and 260, and the MSs 211, 213, 221, 223, 251, 253, 255, 261 and 263, signals are transmitted and received in conformity to the OFDM/OFDMA scheme.

A structure of a multihop relay wireless communication system for increasing system capacity is described with reference to FIG. 3.

FIG. 3 illustrates a simplified structure of a multihop relay broadband wireless communication system for increasing system capacity according to the conventional art.

Referring to FIG. 3, the multihop relay wireless communication system includes a BS 310, MSs 311, 313, 321, 323, 331 and 333, and RSs 320 and 330 which provide multihop relay paths between the BS 310 and the MSs 311, 313, 321, 323, 331 and 333. Between the BS 310, the RSs 320 and 330, and the MSs 311, 313, 321, 323, 331 and 333, signals are transmitted and received using the OFDM/OFDMA scheme. The BS 310 manages a cell 300. The MSs 311, 313, 321, 323, 331 and 333 and the RSs 320 and 330 within the coverage area of the cell 300 may transmit and receive signals directly to and from the BS 310.

However, some MSs 321, 323, 331 and 333 near the boundary of the cell 300 are subject to a low Signal to Noise Ratio (SNR) of the direct links between the BS 310 and the MSs 321, 323, 331 and 333. The RSs 320 and 330 may raise the effective transfer rate of the MSs and increase the system capacity by providing high-speed data transmission paths to the MSs 321, 323, 331 and 333.

In the multihop relay broadband wireless communication system of FIG. 2 or FIG. 3, the RSs 220, 260, 320 and 330 may be infrastructure RSs installed by a service provider and managed by the BSs 210, 250 and 310 which are aware of the existence of the RSs in advance, or client RSs which serve as SSs (or MSs) or RSs in some cases. The RSs 220, 260, 320, and 330 may be stationary, nomadic (e.g., notebook computer), or mobile like the MS.

To relay the data to the lower node in the multihop relay system, the RS should be able to tell whether data received from the upper node (the BS or the upper RS) is destined for the RS or the lower node (the MS or the lower RS). In the conventional art, there has been no suggestion for a specific data format and detailed operation for distinguishing the data.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for distinguishing data to relay to a lower node (a mobile station or a lower relay station) in a multihop relay wireless communication system.

Another aspect of the present invention is to provide a data format for relay in a multihop relay wireless communication system.

Yet another aspect of the present invention is to provide a relay data format for relaying data of a mobile station in a multihop relay wireless communication system.

Still another aspect of the present invention is to provide an apparatus and a method for distinguishing the relayed data using a station identifier and a flow identifier in a multihop relay wireless communication system.

In accordance with an aspect of the present invention, a method for operating a Relay Station (RS) in a multihop relay wireless communication system is provided. The method includes determining whether a packet received from an upper node comprises a Relay Media Access Control (MAC) Header (RMH), when the RMH is comprised in the received packet, determining whether the RMH comprises access RS information, and when the access RS information is not comprised in the RMH, removing the RMH from the received packet and transmitting the packet to a lower Mobile Station (MS).

In accordance with another aspect of the present invention, a method for operating a Base Station (BS) in a multihop relay wireless communication system is provided. The method includes when a relay communication supports two hops, determining whether transmit data is lower MS data of an RS or data of the RS, when the transmit data is data of the RS, generating a packet of a first format with the transmit data, when the transmit data is the lower MS data of the RS, generating a packet of a second format with the transmit data, and transmitting the generated packet to the RS.

In accordance with yet another aspect of the present invention, an RS apparatus in a multihop relay wireless communication system is provided. The apparatus includes a receiver for receiving a packet from an upper node, a packet analyzer for determining whether the received packet comprises an RMH, for determining whether the RMH comprises access RS information when the RMH is comprised in the received packet, and for removing the RMH from the received packet when the access RS information is not comprised in the received packet, and a transmitter for transmitting the packet with the RMH removed to a lower MS.

In accordance with still another aspect of the present invention, a BS apparatus in a multihop relay wireless communication system is provided. The apparatus includes a packet constitutor for, when a relay communication supports two hops, determining whether transmit data is lower MS data of an RS or data of the RS, for generating a packet of a first format with the transmit data when the transmit data is data of the RS, and for generating a packet of a second format with the transmit data when the transmit data is the lower MS data of the RS, and a transmitter for transmitting the generated packet to the RS.

In accordance with a further aspect of the present invention, a method for operating an RS in a multihop relay wireless communication system is provided. The method includes determining whether a packet received from an upper node comprises an RMH, when the RMH is comprised in the received packet, confirming IDentifier (ID) information of a lower node from an Extended Header (EH) which constitutes the RMH, when the lower node is a node having a direct link to the RS, transmitting data destined for the lower node in a payload of the packet, to the lower node, and when the lower node is not a node having a direct link to the RS, generating relay data comprising data of the payload and transmitting the relay data to a next node on a path leading to the lower node.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments the present invention will become more apparent from the following description taken in conjunction with the accompanying drawings, in which:

FIG. 1 illustrates a simplified structure of a conventional Institute of Electrical and Electronics Engineers (IEEE) 802.16e communication system;

FIG. 2 illustrates a simplified structure of a multihop relay broadband wireless communication system for extending a service coverage area of a base station according to the conventional art;

FIG. 3 illustrates a simplified structure of a multihop relay broadband wireless communication system for increasing system capacity according to the conventional art;

FIG. 4 illustrates simplified connections established for packet transmission in a multihop relay wireless communication system according to an exemplary embodiment of the present invention;

FIG. 5 illustrates data formats processed at a relay station in a multihop relay wireless communication system according to an exemplary embodiment of the present invention;

FIGS. 6A through 6E illustrate data constitutions using a relay Media Access Control (MAC) header in a multihop relay wireless communication system according to an exemplary embodiment of the present invention;

FIG. 7 illustrates operations of a base station in a multihop relay wireless communication system according to an exemplary embodiment of the present invention;

FIG. 8 illustrates operations of a relay station in a multihop relay wireless communication system according to an exemplary embodiment of the present invention;

FIG. 9 illustrates a base station in a multihop relay wireless communication system according to an exemplary embodiment of the present invention; and

FIG. 10 illustrates a relay station in a multihop relay wireless communication system according to an exemplary embodiment of the present invention.

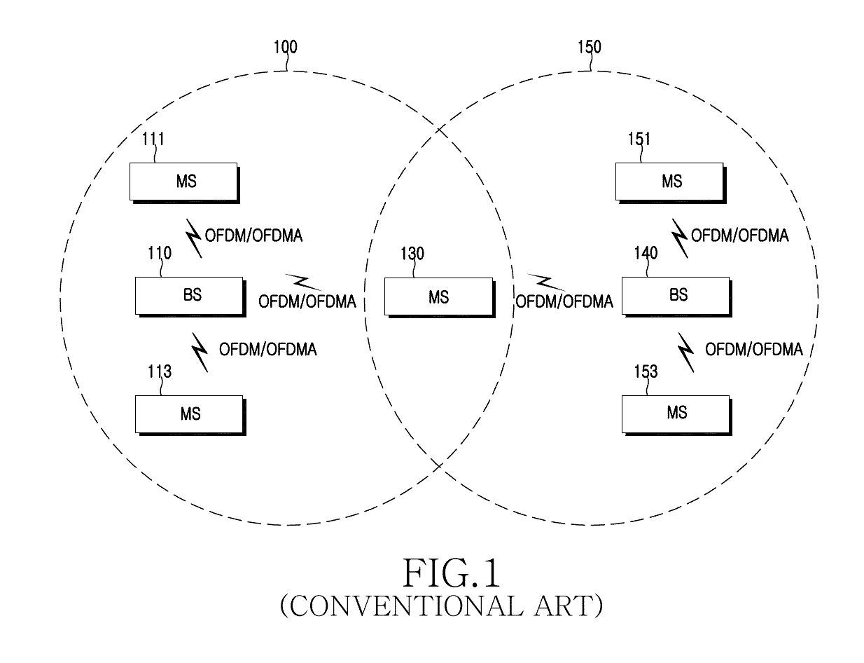

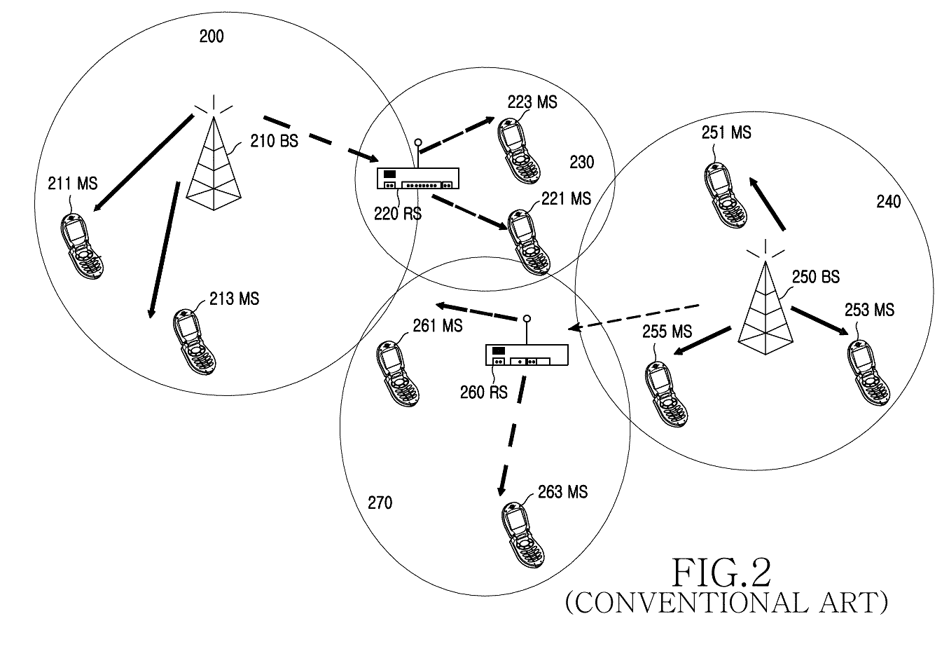

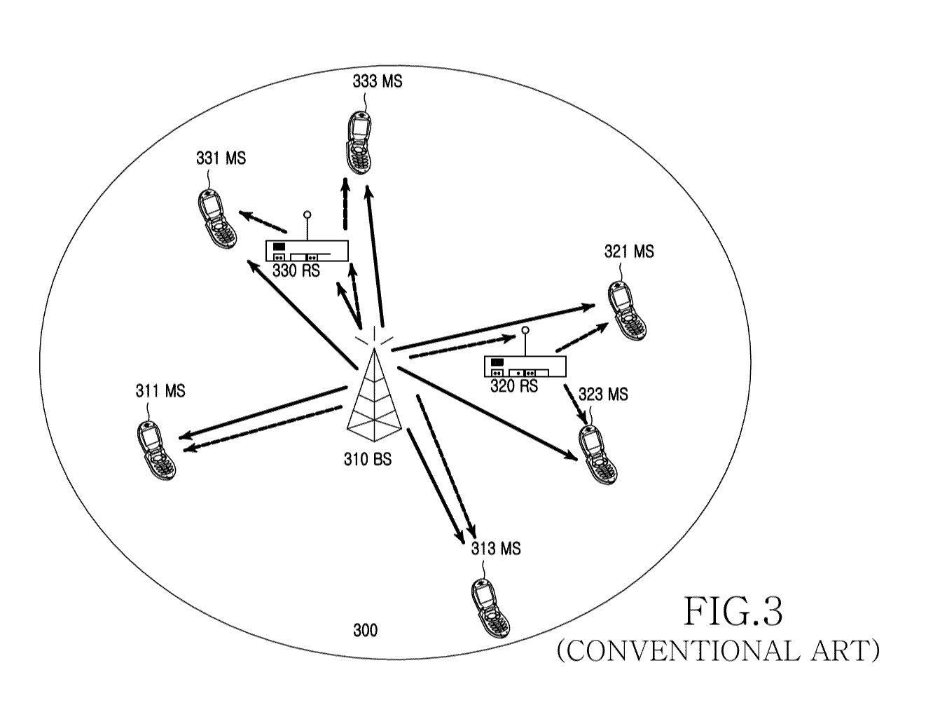

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide a technique for a relay station to distinguish a packet destined for a lower node in a multihop relay broadband wireless communication system.

Since the multihop relay broadband wireless communication system employs an Orthogonal Frequency Division Multiplexing/Orthogonal Frequency Division Multiple Access (OFDM/OFDMA) scheme, it supports high-speed data transmission by sending physical channel signals over a plurality of subcarriers and provides mobility to a Mobile Station (MS) by means of a multi-cell structure.

Hereafter, while the wireless communication system based on the OFDM/OFDMA scheme is illustrated and referred to as example, the present invention is applicable to other multihop relay cellular communication systems.

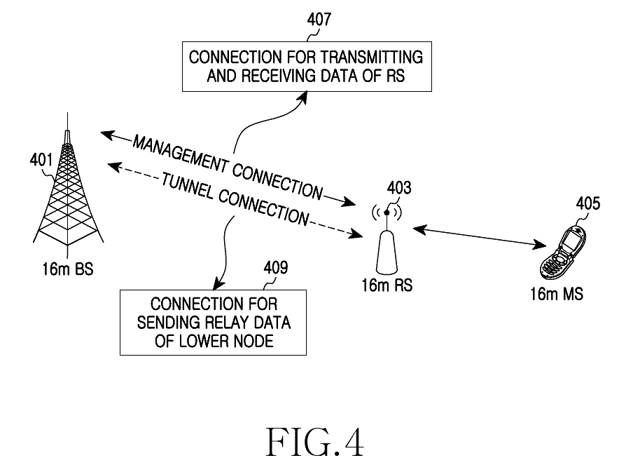

FIG. 4 illustrates simplified connections established for a packet transmission in a multihop relay wireless communication system according to an exemplary embodiment of the present invention.

Referring to FIG. 4, a management connection 407 and a tunnel connection 409 are established between a Base Station (BS) 401 and a Relay Station (RS) 403. The management connection 407 delivers packets for controlling the operations of the RS 403. For example, the management connection 407 is principally used to transmit packets for a basic connection flow, a primary connection flow, and a secondary connection flow of the RS.

Besides the management connection 407, the tunnel connection 409, for carrying packets of an MS 405 serviced by the RS 403 or a lower RS, may be disposed between the RS 403 and the BS 401. To distinguish the management connection 407 and the tunnel connection 409, two identifiers may be assigned to the RS 403. That is, an RS station IDentifier (ID) may be assigned for the management connection 407 and a RS tunnel ID may be assigned for the tunnel connection 409. Herein, the service flow in the tunnel connection 409 may be defined as a tunnel connection flow or a relaying service flow.

When the tunnel connection 409 is not formed between the BS 401 and the RS 403, the packets of the MS 405 may be delivered through the management connection 407. Herein, the packets of the MS 405 cover packets destined for the MS 405 and packets originated from the MS 405.

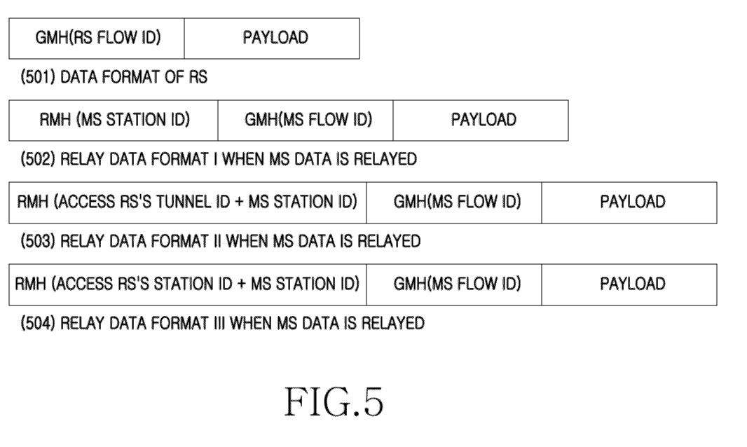

FIG. 5 depicts data formats processed at an RS in a multihop relay wireless communication system according to an exemplary embodiment of the present invention.

Referring to FIG. 5, a first data format 501 may be applied to data delivered to the RS. The first data format 501 includes a Generic Media Access Control (MAC) Header (GMH) including a flow ID of the RS, and a payload. The flow ID represents the basic connection flow, the primary connection flow, and the secondary connection flow using the management connection 407 of FIG. 4. A MAP Information Element (IE) including burst allocation information of the data delivered to the RS is encoded with the RS station ID.

A second data format 502 may be applied to carry data of the MS relay-serviced by the RS. The second data format 502 includes a Relay Media access control Header (RMH) including ID information of the destination MS of the relay data, for example, the MS station ID, and a packet of the MS. The packet of the MS includes a GMH including flow information of the MS and a payload of the MS.

The second data format 502 may be applied to a relay communication with two hops. When the data in the second data format 502 is transmitted, a MAP IE informing of burst allocation information of the data may be encoded with the RS tunnel ID assigned to the tunnel connection of the RS. Alternatively, when the RMH and the GMH may be distinguished, the MAP IE informing of the burst allocation information of the data may be encoded with the RS station ID.

The RMH includes a GMH for the RS and an Extended Header (EH) including ID information of the MS that receives or transmits the relay data. The GMH in the RMH includes a Flow ID (FID) of the RS. The FID of the RS represents one of the basic connection flow, the primary connection flow, the tunnel connection flow, and the relaying service flow. In particular, the tunnel connection FID and the relaying service FID may be used to indicate that the payload following the RMH includes packets destined for or originating from the lower MS of the RS, rather than the packets of the RS itself. For example, the presence of the tunnel connection FID implies that the following payload is the packet of the lower MS, and the presence of the relaying service FID implies that the following payload is the packet of the RS.

The EH including the ID information of the MS has substantially the same format as a general EH. The EH includes at least one ID information, for example, at least one station ID indicative of one lower node or two or more lower nodes which receive or transmit the relay data. For example, the RMH is constituted by combining Table 1 and Table 3 or combining Table 2 and Table 3.

TABLE 1

| | Size | |
|---|---|---|
| Syntax | (bit) | Notes |
| Generic MAC | | |
| Header( ){ | | |
| Flow ID | 4 | FID of RS |
| EH | 1 | Extended header presence indicator. |
| | | As for a packet destined for the lower node of the |
| | | RS, there exists the EH including an ID of the |
| | | lower RS or the MS that receives or transmits the |
| | | relay data. Thus, this bit is set to 1. |
| Length | 11 | Length of payload |
| } | | |

By taking into account the relayed data amount greater than the general data amount, the structure of the GMH in the RMH may differ from the general GMH. The general GMH limits the value of the Length field to 11 bits. However, when the data of the lower MS is relayed, 11 bits may be insufficient. Since a Length field greater than 11 bits is required in some cases, the GMH in the RMH may be defined as shown in Table 2.

TABLE 2

| | Size | |
|---|---|---|
| Syntax | (bit) | Notes |
| Relay Generic | | |
| MAC Header( ){ | | |
| Relay MAC | 1 | This field is always set to 1 to indicate |
| PDU Indicator | | that this header is the GMH for the |
| | | relay. |
| Flow ID | 3-4 | FID of RS |
| EH | 1 | Extended header presence indicator. |
| | | As for a packet destined for the lower |
| | | node of the RS, there exists the EH |
| | | including an ID of the lower RS or the |
| | | MS that receives or transmits the relay |
| | | data. Thus, this bit is set to 1. |
| Length | 12 or more | Length of payload |
| } | | |

The GMH of Table 2 in the RMH starts with a Relay MAC PDU indicator field. The Relay MAC PDU indicator field is always set to 1. The Relay MAC PDU indicator field is followed by the Flow ID field indicative of the FID of the RS which processes the RMH, the EH field indicative of the presence of the EH including the MS information, and the Length field indicative of the size of the relay data. The Relay MAC PDU indicator field is used to tell whether the MAC data received at the RS is its MAC data or MAC data of the lower node of the RS. More specifically, when the first bit of the received MAC data is 1, the RS determines the MAC data to relay to the lower node of the RS. When the first bit of the received MAC data is not 1, the RS determines the MAC data is destined for itself.

TABLE 3

| | Size | |
|---|---|---|
| Syntax | (bit) | Notes |
| Station Info Extended | | |
| Header format( ){ | | |
| LAST | 1 | Indicate whether it is the last EH. |
| Type | | Type of the EH. |
| | | Indicate that this EH is Station Info EH. |
| Num_Station | | Number of nodes to receive packets in |
| | | the following payload. |
| STID | | Station IDs of nodes. |
| | | For a plurality of nodes, a list of the |
| | | station IDs is included. |
| } | | |

The EH of Table 3 lies after the GMH of Table 1 or Table 2. In the 2-hop relay communication, the EH of Table 3 includes information of the destination or source MS of the relay data. The MS information is represented with the station ID of the MS. When the relay data includes data of the multiple MSs, station IDs of the MSs are included.

Yet, when the EH is in the structure of Table 3, the length of the Num_Station field varies according to the number of the station IDs in the STID field. Accordingly, the total length of the EH also changes. In this situation, it is hard to predict the length of the EH and thus the complexity of the entire data analysis increases. To ease the prediction of the EH length, the Num_Station field may be omitted. When the Num_Station field is omitted, an indicator informing of the end of at least one station ID is additionally required because the number of the station IDs in the STID field is not specified. For example, the structure of the EH with the Num_Station field omitted is shown in Table 4.

TABLE 4

| | size | |
|---|---|---|
| syntax | (bit) | notes |
| Station Info Extended | | |
| Header format( ){ | | |
| Do{ | | |
| STID | 12 | Station IDs of nodes |
| End | 1 | Indicates whether next station ID |
| | | follows. |
| | | 0: indicates that current station ID |
| | | is the last station ID in the EH. |
| | | 1: indicates presence of other |
| | | station IDs. |
| } while(!End) | | |
| } | | |

As stated above, the RMH is the combination of the GMH and the EH. In various exemplary embodiments of the present invention, the RMH may be of an independent structure as shown in Table 5. In this case, to distinguish the GMH of Table 1 and the RMH of Table 5, it is advantageous to define a separate tunnel connection flow or a separate relaying service flow for the relay service as described in FIG. 4.

TABLE 5

| | size | |
|---|---|---|
| syntax | (bit) | notes |
| Relay Generic MAC | | |
| Header( ){ | | |
| Flow ID | 4 | Tunnel connection FID or |
| | | relaying service FID of RS |
| Station ID | 12 | Lower MS ID information of RS |
| } | | |

The RMH of Table 5 includes the FID corresponding to the tunnel connection flow or the relaying service flow of the RS which relays the relevant relay data, and the station ID of the destination or source MS of the payload following the RMH. The packets of the MS follow the RMH of Table 5 as the payload, and start with the GMH structured as shown in Table 1. Hence, the RS may determine the length of the data of the MS based on the Length field value of the GMH of the packets of the MS.

When the RMH of Table 5 is used, the relay data may carry packets of only one MS because the station ID of only one MS is included. Yet, to relay the packets of a plurality of MSs subordinate to the RS at the same time, the packets of the RMH structure of Table 5 may be carried by one burst of the RS, and the one burst may be encoded with the station ID of the RS.

The RMH structure of Table 5 may be applied to the relay communication of two hops or three or more hops. As for the relay communication of three or more hops, when the RS receiving the relay data is not an access RS of the destination, the RS needs to forward the relay data to a next RS toward the destination. Accordingly, in the relay communication of three or more hops, it is assumed that RS path information to the destination, that is, next hop RS information leading to the destination is already known to the RSs. In so doing, the Flow ID field of the RMH of Table 5 should be set to the FID of a next hop RS.

Alternatively, besides the RMH of Table 5, an independent RMH of Table 6 may be utilized. For example, when the EH is included with the relay data in addition to the RMH, the RMH of Table 6 may be employed.

TABLE 6

| | size | |
|---|---|---|
| syntax | (bit) | notes |
| Relay Generic | | |
| MAC Header( ){ | | |
| Flow ID | 3 | Tunnel connection FID or relaying |
| | | service FID of RS |
| EH | 1 | Informing whether EH of RS included. |
| Station ID | 12 | Lower MS ID information of RS |
| } | | |

The RMH of Table 6 includes the Flow ID field indicative of the tunnel connection flow or the relaying service flow of the RS which relays the RMH, the EH field indicative of the presence or absence of the EH, and the Station ID field indicative of the ID information of the MS corresponding to the destination of the payload following the RMH. The packet of the MS follows the RMH of Table 6, and starts with the GMH of Table 1. The RMH may be followed by the EH for the RS, and the EH field of Table 6 indicates the presence of the EH. For instance, as the EH for the RS, a bandwidth request signal in the form of the piggyback transmitted from the RS to the BS may be included.

A third data format 503 may be applied to the relay communication in which the number of hops is two or more hops when the RS tunnel ID exists separately. For example, the third data format 503 may be applied to the case of FIG. 4. The third data format 503 includes the RMH including the station ID of the MS which receives or sends the relay data, the station ID of the RS, and the access RS tunnel ID of the MS, that is, the tunnel ID of the RS corresponding to the end of the tunnel, and data of the MS. Herein, the data of the MS includes the GMH including the FID of the MS, and the payload. The data to the RS includes the GMH including the FID of the RS, and the payload to the RS. When the data of the third data format 503 is transmitted, a MAP IE informing of burst allocation information of the data may be encoded with the RS tunnel ID or the RS station ID.

The RMH including the RS tunnel ID is constituted of a combination of Table 1 and Table 3, a combination of Table 2 and Table 3, a combination of Table 1 and Table 4, a combination of Table 2 and Table 4, Table 5 alone, or Table 6 alone. When the relay MAC payload is not processed by an access RS of the MS or an access RS of the RS, the STID field of Table 3 is set to the tunnel ID of the access RS. In contrast, when the relay MAC payload is processed by the access RS of the MS or the access RS of the RS, the STID field of Table 3 is set to the station ID of the MS or the station ID of the RS.

A fourth data format 504 is applied to the relay communication with two or more hops when there exists no separate RS tunnel ID. The fourth data format 504 includes the RMH and the data of the MS or the data to the lower RS. The RMH is constituted of a combination of Table 1 and Table 3, a combination of Table 2 and Table 3, a combination of Table 1 and Table 4, a combination of Table 2 and Table 4, Table 5 alone, or Table 6 alone. The EH includes ID information of the RS or the MS that receives the relay data. The EH includes the station ID of the MS and the station ID of the access RS of the MS or the station ID of the lower RS. The data of the MS includes the GMH including the MS FID and the payload of the MS, and the data to the lower RS includes the GMH including the RS FID and the payload to the RS. When the relay data of the fourth data format 504 is transmitted, a MAP IE informing of burst allocation information of the data may be encoded with the station ID of the RS.

In the relay communication of two or more hops, the EH of Table 3 is used to carry ID information of the destination (e.g., MS, RS or access RS of MA) of the relay data.

When the relay data includes the data of the MS, and the RS to process the relay data is not the access RS of the MS, the station ID of the access RS of the MS is included as the destination information in the EH of Table 3. In contrast, when the RS to process the relay data is the access RS of the MS, the station ID of the MS is included as the destination information in the EH of Table 3.

When the relay data includes the data of an RS A, and the RS to process the relay data is not the access RS of the RS A, the destination information in the EH of Table 3 includes the station ID of the access RS of the RS A. In contrast, when the RS to process the relay data is the access RS of the RS A, the destination information in the EH of Table 3 includes the station ID of the RS A.

The Length field is provided to calculate the amount of the data to be processed by the MS, the RS, or the access RS. Hence, the RS determines the amount of the data based on the Length field in the GMH of the packet of the MS or the RS in the payload of the relay data, or the Length field in the GMH of the relay data of the access RS. Instead of implicitly calculating the amount of the data as described above, the EH of Table 3 may include length information, included in the relay MAC payload, of a packet to be sent to the destination of the packet or a packet to be sent to the next hop RS toward the destination. At this time, the packet length information added is set to the same value as the Length field value of the GMH of the packet of the MS or the RS, or the Length field value of the GMH of the relay data of the access RS.

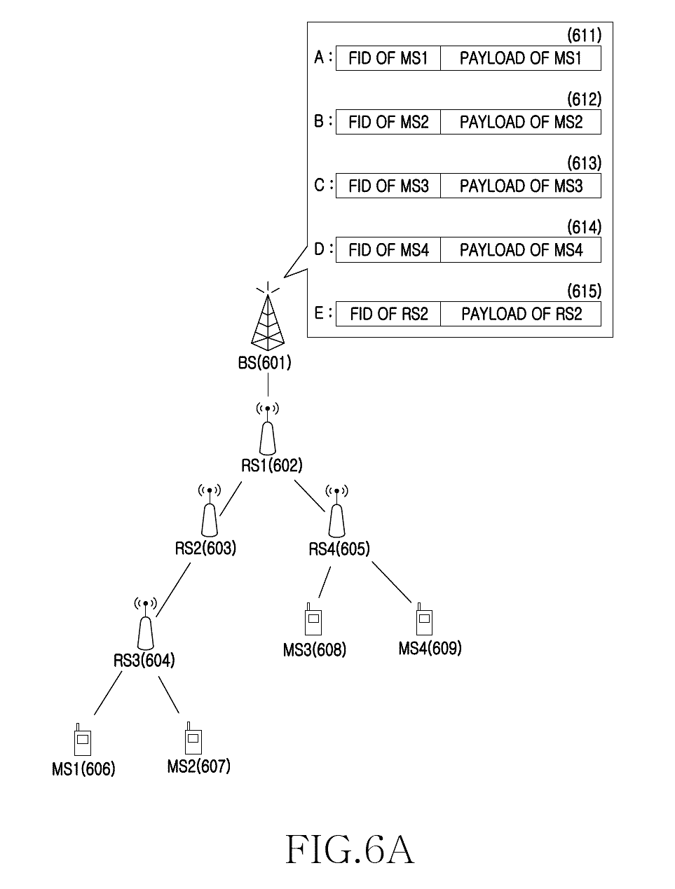

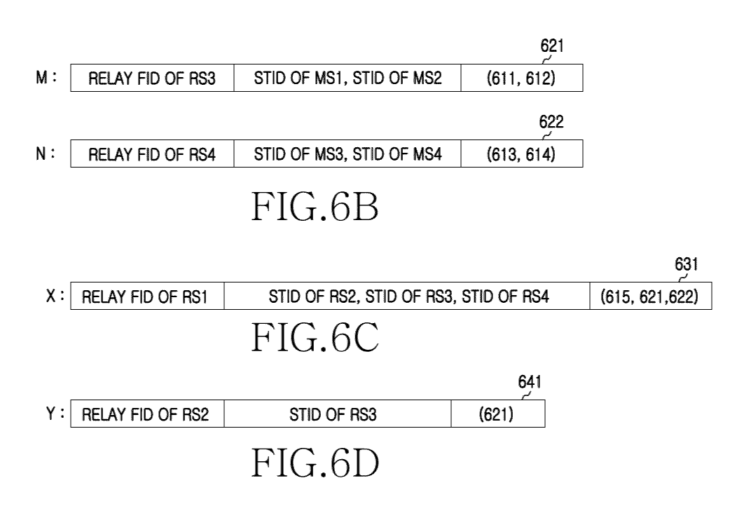

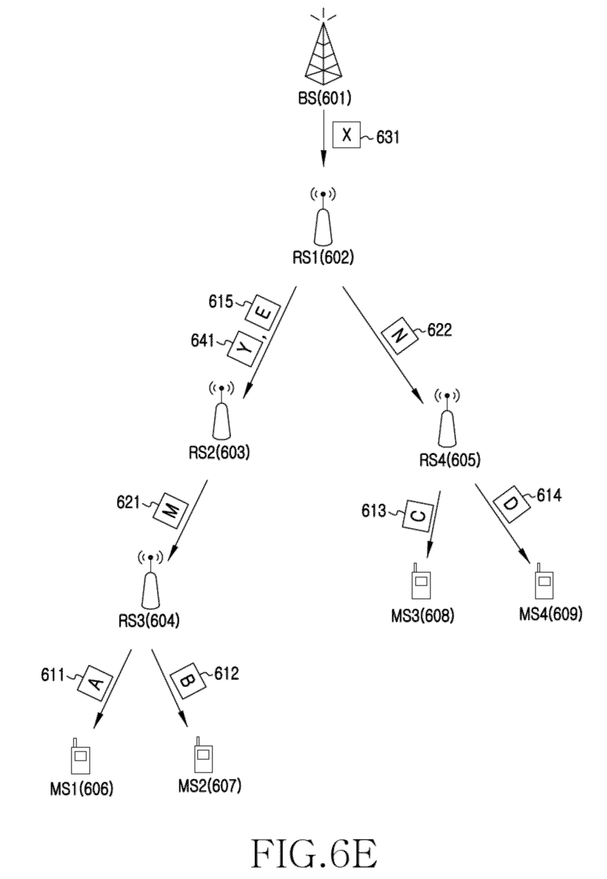

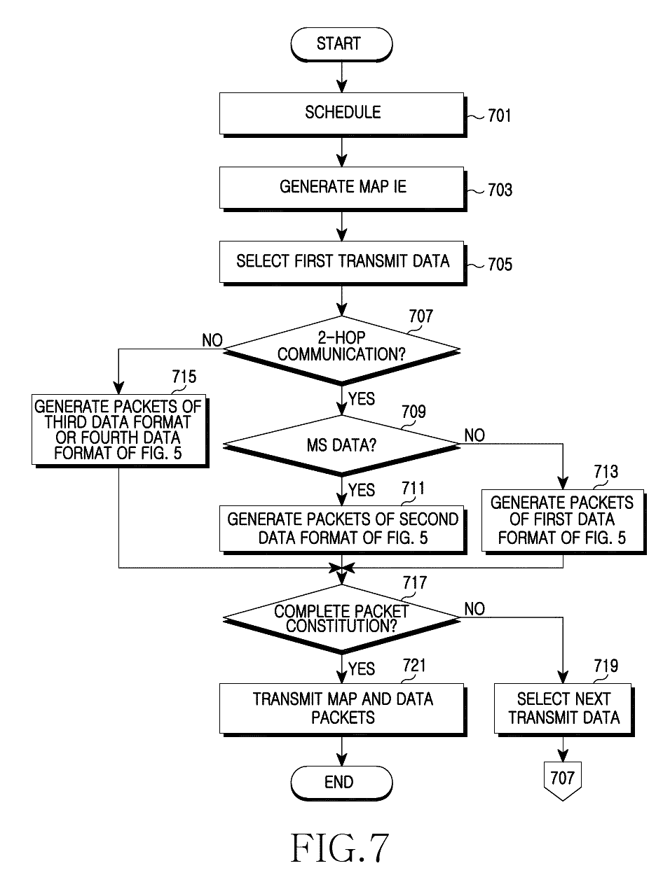

In the relay communication using the RMH of Table 1 and Table 2, the detailed data constitution is now explained. FIGS. 6A through 6E depict data constitutions using the RMH in the multihop relay wireless communication system according to an exemplary embodiment of the present invention.

Referring first to FIG. 6A, a network is configured by a BS 601, an RS1 602, an RS2 603, an RS3 604, an RS4 605, an MS1 606, an MS2 607, an MS3 608, and an MS4 609. The MS1 606 and the MS2 607 have the 4-hop link including the RS1 602, the RS2 603, and the RS3 604, and the MS3 608 and the MS4 609 have the 3-hop link including the RS1 602 and the RS4 605.

The BS 601 has downlink data A 611 through data E 615 to transmit. The data A 611 is destined for the MS1 606, the data B 612 is destined for the MS2 607, the data C 613 is destined for the MS3 608, the data D 614 is destined for the MS4 609, and the data E 615 is destined for the RS2 603. The data A 611 through data E 615 each include the FID of the destination and the payload to transmit as shown in FIG. 6A.

To transmit the data A 611 through data E 615 in the relay links, the BS 601 generates relay data using the aforementioned RMH. First, as for the data A 611 and the data B 612 to transmit to the MS1 606 and the MS2 607, since the access RS of the MS1 606 and the MS2 607 is the RS3 604, the BS 601 generates data M 621 of FIG. 6B including the FID of the RS3 604. In the data M 621 of FIG. 6B, the GMH includes the relay FID of the RS3 604, the EH includes the ID information, that is, the station IDs of the MS1 606 and the MS2 607, and the data A 611 and the data B 612 are included as the payload. As for the data C 613 and the data D 614 to transmit to the MS3 608 and the MS4 609, since the access RS of the MS3 608 and the MS4 609 is the RS4 605, the BS 601 generates data B 222 of FIG. 6B including the relay FID of the RS4 605. In the data N 622 of FIG. 6B, the GMH includes the relay FID of the RS4 605, the EH includes the ID information; that is, the station IDs of the MS3 608 and the MS4 609, and the data C 613 and the data D 614 are included as the payload.

Since the RS3 604 and the RS4 605 are the nodes having the links directly connected to the BS 601, the BS 601 may not transmit the data M 621 and the data N 622 as it is but instead needs to reconstruct relay data including the data M 621 and the data N 622 as the payload. As a result, data X 631 of FIG. 6C and data Y 632 of FIG. 6D are generated. Since the node having the direct link to the BS 601 is the RS1 602, the RS 601 generates the data X 631 including the relay FID of the RS1 602. In the data X 631 of FIG. 6C, the GMH includes the relay FID of the RS1 602, the EH includes the ID information, that is, the station IDs of the RS3 604 and the RS4 605, and the data M 621 and the data N 622 are included as the payload. Since there exists the data E 615 intended for the RS2 603, the EH of the data X 631 includes the ID information, that is, the station ID of the RS2 603 and the data E 615 is carried as the payload. In result, the data X 631 is delivered from the BS 601 to the RS1 602 as shown in FIG. 6E.

The RS1 602 receiving the data X 631 confirms the presence of the EH indicative of the ID information of the lower node and thus determines that the data X 631 is the relayed data. Correspondingly, the RS1 602 generates the data Y 641, the data N 622, and the data E 615 from the data X 631. In more detail, the RS1 602 determines from the EH that the data X 631 includes the data for the RS2 602, the data for the RS3 604, and the data for the RS4 605, separates the data in the payload, and generates the data M 621, the data N 622, and the data E 615. Next, the RS1 602 generates the relay data Y 641 including the data M 621. To separate the data, the RS1 602 needs to know the lengths of the data M 621, the data N 622, and the data E 615. Herein, the length of each data is acquired from the GMH of the data, or from the length fields per data in the EH of the data X 631. The RS1 602 sends the data Y 641 and the data E 615 to the RS2 603 and sends the data N 622 to the RS4 605 as shown in FIG. 6E.

The RS4 605 receiving the data N 622 confirms the presence of the EH indicative of the ID information of the lower node and thus determines that the data N 622 is the relayed data. Next, the RS4 605 determines from the EH that the data for the MS3 608 and the data for the MS4 609 are included, separates the data in the payload, and generates the data C 613 and the data D 614. To separate the data, the RS4 605 needs to know the lengths of the data C 613 and the data D 614. Herein, the length of each data is acquired from the GMH of the data, or from the length fields per data in the EH of the data N 622. The RS4 605 sends the data C 613 to the MS3 608 and sends the data D 614 to the MS4 609 as shown in FIG. 6E.

The RS2 603 receiving the data Y 641 and the data E 615 determines that the data Y 641 is the relay data by confirming the presence of the EH indicative of the ID information of the lower node and determines the data E 615 is destined for itself by confirming the absence of the EH indicative of the ID information of the lower node. Hence, the RS2 603 processes the data E 615 and generates the data M 621 from the data Y 641. Since the payload of the data Y 641 includes only the data M 621, the RS2 603 generates the data M 621 by removing the GMH and the EH. Next, the RS2 603 sends the data M 621 to the RS3 604 as shown in FIG. 6E.

The RS3 604 receiving the data M 621 determines that the data M 621 is the relayed data by confirming the presence of the EH indicative of the ID information of the lower node. Next, the RS3 604 determines from the EH that the data of the MS1 606 and the data of the MS2 607 are included and constitute the data A 611 and the data B 612 by separating the data in the payload. To separate the data, the RS3 604 needs to know the lengths of the data A 611 and the data B 612. Herein, the length of each data is acquired from the GMH of the data, or from the length fields per data in the EH of the data M 621.

The RS3 604 sends the data A 611 to the MS1 606 and the data B 612 to the MS2 607 as shown in FIG. 6E.

In this exemplary embodiment, the present invention provides the EH including the ID of the MS/RS and the ID of the access RS as one structure as shown in Table 3. Alternatively, an EH-1 including the ID of the MS/RS for the data of the MS/RS and an EH-2 including the ID of the access RS for the data of the access RS may be defined.

Meanwhile, the data 501 to the RS and the data 502 through 504 to the lower MS of the RS or the lower RS of the RS may be multiplexed to one burst to be processed by the RS. At this time, the EH for distinguishing the multiplexed data may be attached in front of the multiplexed data. The EH follows the GMH of the RMH and corresponds to the multiplex EH used to support the multiplexing of the generic MAC data or the multiplex EH changed for the relay link.

FIG. 7 illustrates operations of a BS in a multihop relay wireless communication system according to an exemplary embodiment of the present invention.

Referring to FIG. 7, in step 701, the BS performs the resource scheduling. The BS may allocate the resources using a distributed scheduling or a centralized scheduling. In step 703, the BS generates the MAP IEs using the scheduling result.

In step 705, the BS selects the first transmit data from the data to transmit in the current frame. In step 707, the BS determines whether the 2-hop communication is supported. When two or more hops are supported, the BS generates packets of the third data format 503 or the fourth data format 504 of FIG. 5 with the selected transmit data in step 715 and proceeds to step 717.

When supporting only the 2-hop communication, the BS determines whether the selected transmit data is the lower MS data of the RS in step 709. When the selected transmit data is the lower MS data of the RS, the BS generates the packets of the second data format 502 of FIG. 5 with the selected transmit data in step 711 and proceeds to step 717. In contrast, when the selected transmit data is not the lower MS data of the RS, that is, the data processed by the RS, the BS generates the packets of the first data format 501 of FIG. 5 with the selected transmit data in step 713 and proceeds to step 717.

In step 717, the BS determines whether all of the packets to transmit in the current frame are generated. When the packet constitution is not completed, the BS selects next transmit data in step 719 and returns to step 707. When the packet constitution is completed, the BS transmits the generated MAP IEs and the generated data packets in step 721. For example, the MAP IEs each may be encoded (e.g., Cyclic Redundancy Check (CRC) encoded) with the corresponding ID (the station ID, the tunnel ID, etc.), encoded and modulated at the corresponding Modulation and Coding Scheme (MCS) level, mapped to the corresponding resources, and then transmitted. The data packets each may be encoded and modulated at the corresponding MCS level, mapped to the resources according to the scheduling result, and then transmitted.

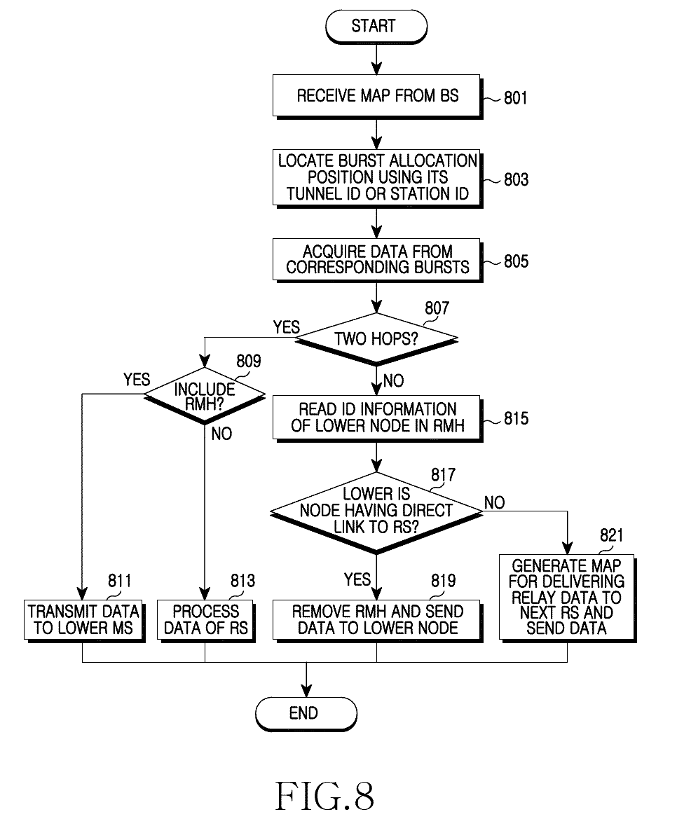

FIG. 8 illustrates operations of an RS in a multihop relay wireless communication system according to an exemplary embodiment of the present invention.

Referring to FIG. 8, in step 801, the RS receives the MAP from the BS. In step 803, the RS locates the allocation position of the burst to receive by decoding the MAP using its RS ID or its RS tunnel ID in step 803. For example, the RS splits the data of the received MAP into the set unit, demodulates and decodes the units at the set MCS level, and determines the CRC of the decoded data using the RS ID or the RS tunnel ID. When detecting no error, the RS determines that its MAP IEs are received and locates the allocation position of the burst using the MAP IEs.

When there exists the burst transmitted to the RS, the RS acquires the packets of the burst by receiving and demodulating the corresponding burst using the allocation position of the burst acquired from the MAP in step 805.

As described in FIG. 5, the different data formats are applied to the case where the relay communication supports only two hops and the case where the relay communication supports two or more hops. Accordingly, the RS determines whether the relay communication supports two hops in step 807.

When supporting only the 2-hop relay communication, the RS checks whether the packets include the RMH in step 809. For example, when the MAC header of Table 1 or Table 5 is used, the RS checks whether the EH indicative of the MS ID information is included or whether the FID in the GMH is the relay FID. In contrast, when the MAC header of Table 2 is used, the RS checks whether the RMH is included, based on the Relay MAC PDU Indicator value indicative of the relay MAC PDU. When the MAC header of Table 5 is used, the RS checks whether the FID in the MAC header is the relay FID.

When the RMH is included, the packets are the data to transmit to the lower MS. In step 811, the RS acquires the MS ID information in the MAC header; that is, the MS station ID and transmits the data of the payload of the packets to the MS pointed by the ID information.

In contrast, when the RMH is not included, the packets are destined for the RS. Hence, the RS directly processes the packets as its data in step 813. In so doing, when the data to the RS and the data of the lower MS of the RS are multiplexed, the RS first processes the multiplex EH in the received packets and processes the data of the RS and the lower MS respectively.

When supporting the relay communication of two or more hops, the RS reads the ID information, that is, the station ID of the lower node from the EH including the ID information of the lower node in the MAC header of the received packets in step 815. Herein, the lower node is at least one of the access RS of the relay link and the destination node. For example, when the RS is the access RS, the ID information of the corresponding destination node is provided. When the RS is not the access RS, the ID information of the access RS is provided. Herein, the ID information of the access RS is one of the station ID of the RS and the RS tunnel ID in the EH.

In step 817, the RS determines whether the node indicated by the ID information of the lower node in the EH is the lower node having the direct link to the RS. When the lower node is the node having the direct link to the RS, the RS transmits the data of the payload of the packets to the lower node pointed by the ID information in step 819. In so doing, the RS may generate the MAP to send the corresponding packets to the MS. Also, the RS may remove the RMH.

When the lower node is not the node having the direct link to the RS, the RS generates the relay data including the data of the payload of the packets and sends the relay data to the next hop RS in the path leading to the lower node pointed by the ID information in step 821. Herein, the relay data includes the GMH including the FID of the next node, the EH including the ID information of the lower node, and the data in the payload. It is assumed that the RS is aware of the information of the next hop RS in the path toward the access RS. Also, the RS may generate the MAP for carrying the packets to the next hop RS.

The operations of FIG. 8 may be applied to the RS in the relay communication system based on the distributed scheduling. When the centralized scheduling is employed, for the operations of FIG. 8, the BS provides the RS with the MS station ID, the encoding information (MCS level), and the burst allocation information as the information for encoding the MAP of the MS. In the system supporting more than two hops, the RS station ID or the RS tunnel ID, the encoding information (MCS level), and the burst allocation information may be provided as the information for encoding the MAP of another RS.

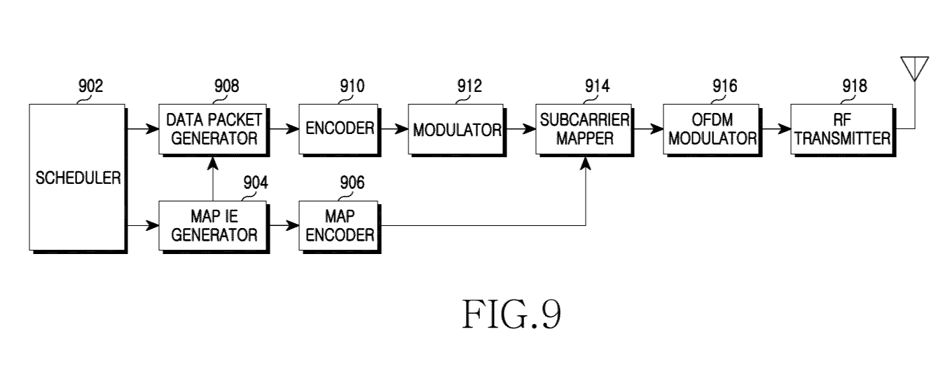

FIG. 9 is a block diagram of a BS in a multihop relay wireless communication system according to an exemplary embodiment of the present invention.

Referring to FIG. 9, the BS includes a scheduler 902, a MAP IE generator 904, a MAP encoder 906, a data packet generator 908, an encoder 910, a modulator 912, a subcarrier mapper 914, an OFDM modulator 916, and a Radio Frequency (RF) transmitter 918.

The scheduler 902 schedules the resources for the frame communication. The scheduler 902 may perform the centralized scheduling or the distributed scheduling.

The MAP IE generator 904 generates the MAP IEs using the scheduling result. The MAP encoder 906 encodes the MAP IEs output from the MAP IE generator 904. In case of the separate encoding, the MAP encoder 906 encodes the MAP IEs individually. For example, the MAP encoder 906 may CRC-process the MAP IEs using the corresponding IDs (station ID, tunnel ID, etc.) and encode and modulate the CRC-added information at the corresponding MCS level.

The data packet generator 908 generates data packets to transmit in the current frame. In this exemplary embodiment, the data packet generator 908 may generate the packets according to the number of the hops and the destination as described above with reference to FIG. 5. For example, when the relay communication supports two or more hops, the data packet generator 908 may generate the transmit data as the packets of the third data format 503 or the fourth data format 504 of FIG. 5.

The encoder 910 channel-encodes the packets (or bursts) output from the data packet generator 908. The modulator 912 modulates the encoded data output from the encoder 910. The subcarrier mapper 914 maps the modulated data output from the modulator 912 and the MAP data output from the MAP encoder 906 to the resources according to the scheduling result of the scheduler 902. The OFDM modulator 916 converts the resource-mapped data output from the subcarrier mapper 914 to time-domain data through Inverse Fast Fourier Transform (IFFT) and generates OFDM symbols by inserting a guard interval (e.g., Cyclic Prefix (CP)). The RF transmitter 918 up-converts the OFDM symbols into an RF signal and then transmits the RF signal over an antenna.

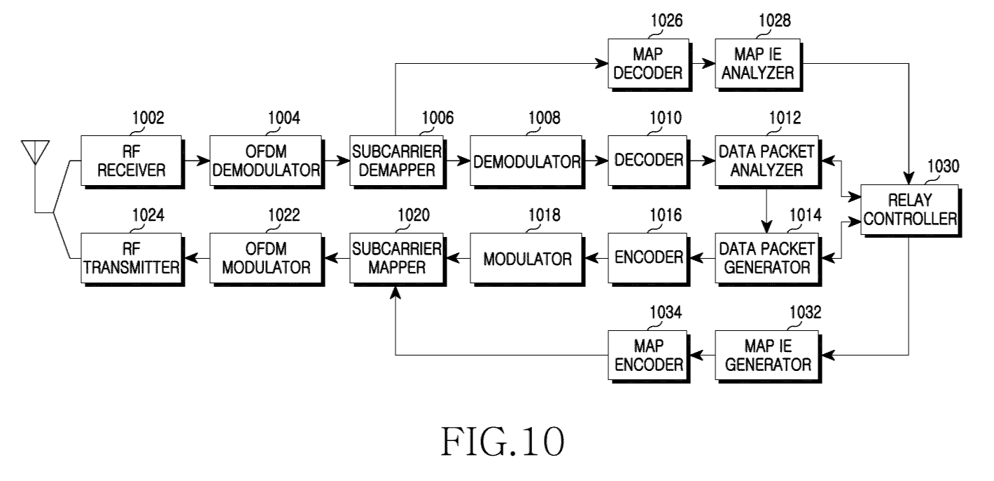

FIG. 10 is a block diagram of an RS in a multihop relay wireless communication system according to an exemplary embodiment of the present invention.

Referring to FIG. 10, the RS includes an RF receiver 1002, an OFDM demodulator 1004, a subcarrier demapper 1006, a demodulator 1008, a decoder 1010, a data packet analyzer 1012, a data packet generator 1014, an encoder 1016, a modulator 1018, a subcarrier mapper 1020, an OFDM modulator 1022, an RF transmitter 1024, a MAP decoder 1026, an MAP IE analyzer 1028, a relay controller 1030, a MAP IE generator 1032, and a MAP encoder 1034.

The RF receiver 1002 down-converts the RF signal received over an antenna into a baseband signal. The OFDM demodulator 1004 generates frequency-domain data by FFT-processing the signal output from the RF receiver 1002. The subcarrier demapper 1006 arranges the frequency-domain data by bursts and outputs the arranged bursts to the decoder 1010. The subcarrier demapper 1006 extracts the MAP data from the frequency-domain data and provides the extracted MAP data to the MAP decoder 1026.

The demodulator 1008 demodulates the data output from the subcarrier demapper 1006. The decoder 1010 restores the information bit stream (the received packets) by channel-decoding the demodulated data output from the demodulator 1008.

The MAP decoder 1026 determines whether the MAP IEs of the RS exist by decoding the MAP data output from the subcarrier demapper 1008 with the ID or the tunnel ID of the RS, and provides the MAP IEs of the RS to the MAP IE analyzer 1028. The MAP IE analyzer 1028 analyzes the MAP IEs of the RS and provides the result to the relay controller 1030.

The relay controller 1030 locates the allocation position of the bursts to receive using the MAP IEs and issues a control signal to the physical layer to receive and demodulate the bursts.

The data packet analyzer 1012 analyzes the packets received from the upper node. When the relay communication supports only two hops, the data packet analyzer 1012 determines whether the received packets from the decoder 1012 include the RMH. For example, when the GMH of Table 1 is used, the data packet analyzer 1012 checks whether the EH indicative of the MS ID information is included, or whether the FID in the GMH is the relay FID. When the MAC header of Table 2 is used, the data packet analyzer 1012 checks whether the RMH is included, based on the Relay MAC PDU Indicator value indicative of the relay MAC PDU. When the MAC header of Table 5 is used, the data packet analyzer 1012 checks whether the FID in the MAC header is the relay FID. When the RMH is included, it implies the data is data to transmit to the lower MS. Hence, the data packet analyzer 1012 removes the RMH from the received packets and provides to the data packet generator 1014. When the RMH is not included, it implies the data is data to be processed by the RS. Hence, the data packet analyzer 1012 provides the received packets to the relay controller 1030.

Meanwhile, when the relay communication supports two or more hops, the data packet analyzer 1012 analyzes the RMH from the received packets output from the decoder 1010 and confirms the lower node ID information based on the EH including the lower node ID information in the RMH. Herein, the lower node is at least one of the access RS of the relay link and the destination node. For example, when the RS is the access RS, the ID information of the corresponding destination node is present. When the RS is not the access RS, the ID information of the access RS is present. Herein, the ID information of the access RS is one of the station ID of the RS and the RS tunnel ID in the EH. The data packet analyzer 1012 determines whether the node pointed to by the lower node ID information of the EH is the lower node having the direct link to the RS. When the lower node is the node having the direct link to the RS, the data packet analyzer 1012 provides the lower node ID information to the relay controller 1030 and provides the data of the payload of the packets to the data packet generator 1014. Accordingly, the relay controller 1030 controls to deliver the data in the payload to the lower node pointed to by the ID information, and controls the MAP IE generator 1032 to generate the MAP for transmitting the data. When the lower node is not the node having the direct link to the RS, the data packet analyzer 1012 provides the data to the data packet generator 1014 to send the data in the payload of the packets to the next hop RS in the path leading to the lower node. The relay controller 1030 controls the MAP IE generator 1032 to generate the MAP for the packets transmitted to the next hop.

The data packet generator 1014 generates the packets to send to the lower node and outputs the generated packets to the encoder 1016. When generating the packets to send to the RS, which is not the access RS, the data packet generator 1014 generates the relay data by inserting the RMH to the data output from the data packet analyzer 1012. Herein, the relay data includes the GMH including the FID of the next node on the path to the access RS, the EH including the ID information of the access RS, and the data in the payload. The data packet generator 1014 temporarily stores the packets received from the upper node, and provides the stored packets to the encoder 1016 under the control of the relay controller 1030.

The MAP IE generator 1032 generates the MAP IEs under the control of the relay controller 1030 and outputs the generated MAP IEs to the MAP encoder 1034. The MAP encoder 1034 encodes the MAP IEs output from the MAP IE generator 1032.

The encoder 1016 channel-encodes the packets output from the data packet generator 1014. The modulator 1018 demodulates the channel-encoded bit stream. The subcarrier mapper 1020 maps the modulated data output from the modulator 1018 and the MAP data output from the MAP encoder 1034 to the resources. The OFDM modulator 1022 converts the resource-mapped data output from the subcarrier mapper 1020 to time-domain data through the IFFT and generates OFDM symbols by inserting the CP. The RF transmitter 1024 up-converts the baseband signal into an RF signal and then transmits the RF signal over an antenna.

As set forth above, the present invention provides a solution for distinguishing the data relayed to the MS and the data to be processed by the RS. That is, by virtue of the new data formats for the relayed data, the RS may more easily provide the relay service.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for operating a Relay Station (RS) in a multihop relay wireless communication system, the method comprising:
determining whether a packet received from an upper node comprises a Relay Media Access Control (MAC) Header (RMH);
when the RMH is comprised in the received packet, determining whether the RMH comprises access RS information; and
when the access RS information is not comprised in the RMH, removing the RMH from the received packet and transmitting the packet to a lower Mobile Station (MS).

2. The method of claim 1, wherein the received packet comprises an RMH comprising a station IDentifier (ID) of the lower MS and MS data, and wherein the MS data comprises a Generic MAC Header (GMH) comprising a Flow ID (FID) of the MS, and a payload.

3. The method of claim 1, further comprising:
when the RMH is not comprised in the received packet, processing the received packet at the RS.

4. The method of claim 3, wherein the received packet comprises a GMH comprising an FID of the RS, and a payload.

5. The method of claim 1, further comprising:
when the access RS information is comprised in the RMH, determining whether the access RS is the RS itself;
when the access RS is the RS itself, removing the RMH from the received packet and transmitting the packet to a lower MS; and
when the access RS is not the RS, transmitting the received packet to a next hop RS on a relay path.

6. The method of claim 5, wherein the received packet comprises the RMH comprising access RS information and a station ID of the lower MS, and MS data, and wherein the MS data comprises a GMH comprising an FID of the MS, and a payload.

7. The method of claim 6, wherein the access RS information comprises one of a station ID of the access RS and a tunnel ID of the access RS.

8. A method for operating a Base Station (BS) in a multihop relay wireless communication system, the method comprising:
when a relay communication supports two hops, determining whether transmit data is lower Mobile Station (MS) data of a Relay Station (RS) or data of the RS;
when the transmit data is data of the RS, generating a packet of a first format with the transmit data;
when the transmit data is the lower MS data of the RS, generating a packet of a second format with the transmit data; and
transmitting the generated packet to the RS.

9. The method of claim 8, wherein the packet of the first format comprises a General Media Access Control (MAC) Header (GMH) comprising a Flow IDentifier (FID) of the RS, and a payload.

10. The method of claim 8, wherein the packet of the second format comprises a Relay MAC Header (RMH) comprising a station ID of the lower MS, and MS data, and wherein the MS data comprises a GMH comprising an FID of the lower MS, and a payload.

11. The method of claim 8, further comprising:
when the relay communication supports two or more hops, generating a packet of a third format comprising access RS information with the transmit data.

12. The method of claim 11, wherein the packet of the third format comprises an RMH comprising the access RS information and a station ID of the lower node, and MS data, and wherein the MS data comprises a GMH comprising an FID of the lower node, and a payload.

13. A Relay Station (RS) apparatus in a multihop relay wireless communication system, the apparatus comprising:
a receiver for receiving a packet from an upper node;
a packet analyzer for determining whether the received packet comprises a Relay Media Access Control (MAC) Header (RMH), for determining whether the RMH comprises access RS information when the RMH is comprised in the received packet, and for removing the RMH from the received packet when the access RS information is not comprised in the received packet; and
a transmitter for transmitting the packet with the RMH removed to a lower Mobile Station (MS).

14. The apparatus of claim 13, wherein the received packet comprises an RMH comprising a station IDentifier (ID) of the lower MS and MS data, and
wherein the MS data comprises a Generic MAC Header (GMH) comprising a Flow ID (FID) of the MS, and a payload.

15. The apparatus of claim 13, further comprising:
a controller for processing the received packet when the RMH is not comprised in the received packet.

16. The apparatus of claim 15, wherein the received packet comprises a GMH comprising an FID of the RS and a payload.

17. The apparatus of claim 13, wherein the packet analyzer determines whether the access RS itself is the RS when the access RS information is comprised in the received packet, removes the RMH from the received packet and then provides the packet to the transmitter to transmit the packet to the lower MS when the access RS is the RS, and provides the received packet to the transmitter to deliver the received packet to a next hop RS on a relay path when the access RS is not the RS.

18. The apparatus of claim 17, wherein the received packet comprises the RMH comprising access RS information and a station ID of the lower MS, and MS data, and wherein the MS data comprises a GMH comprising an FID of the MS, and a payload.

19. The apparatus of claim 18, wherein the access RS information comprises one of a station ID of the access RS and a tunnel ID of the access RS.

20. A Base Station (BS) apparatus in a multihop relay wireless communication system, the apparatus comprising:
a packet constitutor for, when a relay communication supports two hops, determining whether transmit data is lower Mobile Station (MS) data of a Relay Station (RS) or data of the RS, for generating a packet of a first format with the transmit data when the transmit data is data of the RS, and for generating a packet of a second format with the transmit data when the transmit data is the lower MS data of the RS; and
a transmitter for transmitting the generated packet to the RS.

21. The apparatus of claim 20, wherein the packet of the first format comprises a General Media Access Control (MAC) Header (GMH) comprising a Flow IDentifier (FID) of the RS, and a payload.

22. The apparatus of claim 20, wherein the packet of the second format comprises a Relay MAC Header (RMH) comprising a station ID of the lower MS, and MS data, and wherein the MS data comprises an RMH comprising an FID of the lower MS, and a payload.

23. The apparatus of claim 20, wherein, when the relay communication supports two or more hops, the packet constitutor generates a packet of a third format comprising access RS information with the transmit data.

24. The apparatus of claim 23, wherein the packet of the third format comprises an RMH comprising the access RS information and a station ID of the lower node, and MS data, and
wherein the MS data comprises a GMH comprising an FID of the lower node, and a payload.

25. A method for operating a Relay Station (RS) in a multihop relay wireless communication system, the method comprising:
determining whether a packet received from an upper node comprises a Relay Media Access Control (MAC) Header (RMH);
when the RMH is comprised in the received packet, confirming IDentifier (ID) information of a lower node from an Extended Header (EH) which constitutes the RMH;
when the lower node is a node having a direct link to the RS, transmitting data destined for the lower node in a payload of the packet, to the lower node; and
when the lower node is not a node having a direct link to the RS, generating relay data comprising data of the payload and transmitting the relay data to a next node on a path leading to the lower node.

26. The method of claim 25, wherein the RMH comprises a General MAC header (GMH) and the EH.

27. The method of claim 26, wherein the GMH comprises at least one of a Flow ID (FID) of the RS, an indicator indicative of presence or absence of the EH, and length information of the payload.

28. The method of claim 26, wherein the GMH comprises at least one of an indicator indicating whether the packet comprises relay data, an FID of the RS, an indicator indicative of presence or absence of the EH, and length information of the payload.

29. The method of claim 26, wherein the EH comprises at least one of type information indicating whether the EH provides ID information of a recipient node of the relay data, information of a number of nodes to receive data in the payload, ID information of a node to receive the data in the payload, and length information of the data in the payload.

30. The method of claim 25, wherein the relay data comprises a GMH comprising an FID of the next node, an EH comprising ID information of the lower node, and data in the payload.
